(19) United States
(12) Patent Application Publication
(10) Pub. No.: US 2024/0120548 A1
(43) Pub. Date: Apr. 11, 2024

(54) NON-AQUEOUS SECONDARY BATTERY

(71) Applicant: TOYOTA JIDOSHA KABUSHIKI KAISHA, Toyota-shi (JP)

(72) Inventor: Hiroshi TSUBOUCHI, Nagoya-shi (JP)

(73) Assignee: TOYOTA JIDOSHA KABUSHIKI KAISHA, Toyota-shi (JP)

(21) Appl. No.: 18/357,210

(22) Filed: Jul. 24, 2023

(30) Foreign Application Priority Data
Oct. 6, 2022 (JP) 2022-161972

(51) Int. Cl. H01M 10/0569; H01M 10/0525

(52) U.S. Cl. CPC H01M 10/0569; H01M 10/0525; H01M 2300/0034

(57) ABSTRACT

A non-aqueous secondary battery comprising a negative electrode containing a metallic Li, a positive electrode, a separator, and an electrolyte solution, wherein the electrolyte solution contains fluorinated ethylene carbonate as a solvent in an amount of 85% by volume or more based on the total amount of the solvent, and LiPF₆ as an electrolyte in an amount of 1.0 to 2.0 mol/L.

### CROSS-REFERENCE TO RELATED APPLICATION

This application claims priority to Japanese Patent Application No. 2022-161972 filed on Oct. 6, 2022, incorporated herein by reference in its entirety.

### BACKGROUND

### 1. Technical Field

The present disclosure relates to a non-aqueous secondary battery.

### 2. Description of Related Art

Japanese Unexamined Patent Application Publication No. 2021-34381 (JP 2021-34381 A) describes an electrode assembly of an anode-free primary battery including a separator including a positive electrode side and a negative electrode side opposed to each other, a positive electrode located on the positive electrode side of the separator and including a positive electrode current collector and a positive electrode material, and a negative electrode current collector disposed on the negative electrode side of the separator. Further, JP 2021-34381 A describes that an electrolyte can include, as the lithium salt, LiPF₆, LiBF₄, LiClO₄, LiAsF₆, LiSbF₆, LiAlCL₄, LiGaCl₄, LiNO₃, LiC(SO₂CF₃)₃, LiN(SO₂CF₃)₂, LiSCN, LiO₃SCF₂CF₃, LiC₆F₅SO₃, LiO₂CCF₃, LiSO₃F, LiB(C₆H5)₄, LiCF₃SO₃, and LiDFOB, and can include a fluoroethylene carbonate (FEC) as an organic solvent.

### SUMMARY

In JP 2021-34381 A, for an anode-free Li negative electrode, a primary battery using an electrolyte solution containing a high density of FEC has been proposed, but when the electrolyte solution is used in a secondary battery, further improvement in battery performance is required, so that there is room for improvement.

An object of the present disclosure is to provide a non-aqueous secondary battery capable of stably performing repeated Li dissolution and precipitation, improving maintainability of a discharging capacity, and improving cycling properties.

### Means for Solving the Above Issue Include the Following Aspects

1

A non-aqueous secondary battery includes:
a negative electrode including metallic Li;
a positive electrode;
a separator, and
an electrolyte solution. The electrolyte solution contains a fluorinated ethylene carbonate as a solvent in 85% or more by volume to a total amount of the solvent, and contains LiPF₆ as an electrolyte in 1.0 mol/L to 2.0 mol/L.

2

In the non-aqueous secondary battery according to 1, the electrolyte solution includes a non-fluorinated cyclic carbonate as the solvent.

3

In the non-aqueous secondary battery according to 2, the non-fluorinated cyclic carbonate is at least one of an ethylene carbonate and a propylene carbonate.

4

In the non-aqueous secondary battery according to 3,
a ratio of a content of the fluorinated ethylene carbonate and a total content of the ethylene carbonate and the propylene carbonate in the solvent are from 85:15 to 95:5, and a content of LiPF₆ is 1.5 mol/L to 2.0 mol/L.

According to the present disclosure, a non-aqueous secondary battery capable of stably performing repeated Li dissolution and precipitation, improving maintainability of a discharging capacity, and improving cycling properties is provided.

### DETAILED DESCRIPTION OF EMBODIMENTS

Hereinafter, an embodiment of a non-aqueous secondary battery of the present disclosure will be described in detail.

### Non-Aqueous Secondary Battery

The non-aqueous secondary batteries according to the present embodiment include a negative electrode including a metallic Li, a positive electrode, separators, and an electrolyte solution. The electrolyte solution contains fluorinated ethylene carbonate (hereinafter sometimes simply referred to as “FEC”) as a solvent in an amount of 85% by volume or more based on the total amount of the solvent. The electrolyte solution contains 1.0 to 2.0 mol/L of LiPF₆ as the electrolyte.

According to the non-aqueous secondary batteries of the present embodiment, repeated Li dissolution and precipitation can be stably performed, and the sustainability of the discharging capacity can be improved. That is, the cycle characteristics can be improved.

Although the mechanism by which this effect is achieved is not necessarily clear, it is presumed as follows.

Factors that reduce the sustainability of the discharge capacity include, for example, (1) charge consumption due to electrolyte solution decomposition, (2) charge consumption due to a minute short circuit, and (3) overvoltage due to an increase in resistance.

As for (1), improvement of coating properties and suppression of decomposition of a solvent may be effective measures. Depending on the type of electrolyte and its concentration, the coating composition varies. It is believed that the harder the coating, the less dendrite-growth of Li and the smaller the surface area, the less electrolyte solution is consumed. In addition, it is considered that the higher the flexibility of the coating film, the more Li dissolves and precipitates, the more the film breaks down, and the more the decomposition of the electrolyte solution on the new surface of the metallic Li is suppressed. By appropriately controlling the hardness and flexibility of the coating film, it is possible to enhance the discharge capacity maintaining property. In addition, generally, the higher the concentration, the less the solvent coordinated to Li, and the smaller the amount of the solvent that is easily decomposed.

As for (2), this may be caused by the needle-shaped Li passing through the separators and reaching the positive electrode. It is also believed that acicular growth can be promoted when Li ions diffuse slowly.

As for (3), this is due to deterioration of the surface and bulk of the electrode material and deterioration of the electrolyte solution.

In contrast, the hardness of the coating can be controlled by the content of FEC and LiPF₆ because fluorinated ethylene carbonate (FEC) in solvents and LiPF₆ in electrolytes are thought to form an inorganic-based coating such as LiF upon decomposition. On the other hand, cyclic carbonates containing FEC are considered to be easy to form long-carbon-chain organic coatings upon decomposition, and the flexibility of the coating can be controlled by the content thereof.

In addition, the coordination between Li ions and the solvent-anion (PF₆⁻) varies depending on the salt concentration. A higher concentration promotes the decomposition of the anion. If the concentration is too high, the electrolyte solution becomes highly viscous, Li diffuses slowly, and dendrite-growth may be promoted.

In the non-aqueous secondary battery according to the present embodiment, FEC is contained in an amount of 85% by volume or more based on the total amount of solvents in the electrolyte solution, and LiPF₆ in the electrolyte solution is contained in an o 1/L of 1.0 to 2.0 m. Thus, the hardness of the coating film and the flexibility of the coating film are controlled, and an electrolyte solution composition in which Li is diffused while forming a good coating film is ensured is obtained. As a result, it is presumed that repeated Li dissolution and precipitation can be stably performed, the discharge-capacity maintaining property is improved, and the cycling property is improved.

Next, each member constituting the non-aqueous secondary battery will be described.

The non-aqueous secondary battery includes, for example, an electrode assembly including a negative electrode including a metallic Li, a positive electrode, and a separator disposed between the positive electrode and the negative electrode, and the electrode assembly is disposed in a battery case together with an electrolyte solution (non-aqueous electrolyte solution).

### Electrolyte Solution

### Solvent

The electrolyte solution (non-aqueous electrolyte solution) includes a solvent (non-aqueous solvent) and an electrolyte.

The solvent contains fluorinated ethylene carbonate (FEC, fluoroethylene carbonate) in an amount of 85% by volume or more based on the total amount of the solvent. When the content of the fluorinated ethylene carbonate (FEC) in the solvents is less than 85% by volume, the repeated Li dissolution and precipitation is not stably performed, the discharge-capacity maintaining property is lowered, and the cycling property is deteriorated.
The upper limit of the content of the fluorinated ethylene carbonate (FEC) with respect to the total amount of solvents may be 100% by volume.
The content of the fluorinated ethylene carbonate (FEC) relative to the total amount of the solvents is 85 to 100% by volume, preferably 85 to 92% by volume, more preferably 88 to 92% by volume, and still more preferably 88 to 90% by volume.

When the electrolyte solution contains a solvent other than fluorinated ethylene carbonate (FEC), it is preferable to contain a non-fluorinated cyclic carbonate as the solvent. Examples of the non-fluorinated cyclic carbonate include ethylene carbonate (EC), propylene carbonate (PC), and butylene carbonate (BC). The non-fluorinated cyclic carbonate is preferably at least one of ethylene carbonate (EC) and propylene carbonate (PC).

Other solvents include, for example, linear carbonates such as dimethyl carbonate (DMC), ethyl methyl carbonate (EMC), diethyl carbonate (DEC); lactones such as γ-butyrolactone (GBL) and δ-valerolactone; cyclic ethers such as tetrahydrofuran (THF), 1,3-dioxolane and 1,4-dioxane; linear ethers such as 1,2-dimethoxyethane (DME); carboxylic esters such as methyl formate (MF), methyl acetate (MA) and methyl propionate (MP); and the like.

However, it is preferable that the solvents consist only of fluorinated ethylene carbonate (FEC) or only of fluorinated ethylene carbonate (FEC) and non-fluorinated cyclic carbonate.

The content of the solvent other than the fluorinated ethylene carbonate (FEC) is 15% by volume or less based on the total amount of the solvent.

### Electrolyte

The electrolyte solution contains 1.0 to 2.0 mol/L of LiPF₆ (lithium hexafluoride phosphate) as an electrolyte. When the quantity of LiPF₆ as an electrolyte is less than 1.0 mol/L, or when it is more than 2.0 mol/L, neither of the repeated Li dissolution precipitation is stably performed, the discharge-capacity maintaining property is lowered, the cycling property is deteriorated.

The quantity of the electrolyte LiPF₆ is 1.0 to 2.0 mol/L, preferably 1.0 to 1.5 mol/L.

The electrolyte solution may include an electrolyte other than LiPF₆. Other 30 electrolytes include, for example, lithium tetrafluoroborate (LiBF₄), Li [N(FSO₂)₂], Li [N(CF₃SO₂)₂], and the like.

However, the electrolyte is preferably composed only of LiPF₆.

The electrolyte solution may contain, in addition to the solvent and the electrolyte, various additives such as a thickener, a film forming agent, a gas generating agent, and the like. The electrolyte solution is typically a liquid non-aqueous electrolyte at room temperature (e.g., 25±10° C.). The electrolyte solution typically exhibits a liquid state in the use environment of the battery (for example, in a temperature environment of −20 to +60° C.).

In the present embodiment, it is preferable that the electrolyte solution contains a non-fluorinated cyclic carbonate in addition to the fluorinated ethylene carbonate as a solvent, and the non-fluorinated cyclic carbonate is at least one of ethylene carbonate and propylene carbonate. It is more preferable that the content of fluorinated ethylene carbonate and the total content of ethylene carbonate and propylene carbonate be 85:15 to 95:5, and the content of LiPF₆ be 1.5 to 2.0 mol/L.

### Negative Electrode Comprising a Metallic Li

The negative electrode includes, for example, a negative electrode current collector and a negative electrode active material layer fixed on the negative electrode current collector. As the negative electrode current collector, a conductive member made of a metal having good conductivity (for example, copper) is preferable. The negative electrode active material layer includes a negative electrode active material. Examples of the negative electrode active material include graphite-based carbon such as natural graphite, artificial graphite, and amorphous coated graphite. The proportion of graphite in the graphite-based carbon is approximately 50 mass % or more, preferably 80 mass % or more. The negative electrode active material layer may be composed of only the negative electrode active material, or may contain components other than the negative electrode active material, for example, a thickener, a binder, or the like as necessary. Examples of the thickener include celluloses such as carboxymethylcellulose (CMC). Examples of the binder include rubbers such as styrene-butadiene copolymer (SBR) and vinyl halide resins such as polyvinylidene fluoride (PVdF).

In the negative electrode, a negative electrode containing a metallic Li is formed by depositing Li at the time of charge.

### Positive Electrode

The positive electrode includes, for example, a positive electrode current collector and a positive electrode active material layer fixed on the positive electrode current collector. As the positive electrode current collector, a conductive member made of a metal having good conductivity (for example, aluminum) is preferable. The positive electrode active material layer includes at least a positive electrode active material and a conductive material. The positive electrode active material layer may be composed of a positive electrode active material and a conductive material, or may contain other components such as a binder and various additives. Examples of the binder include vinyl halide resins such as polyvinylidene fluoride (PVdF).

Examples of the positive electrode active material include a lithium nickel-cobalt-manganese complex oxide (hereinafter, sometimes simply referred to as “LNCM”). The simplest LNCM is represented by the following general formula: LiNiₓCo_{y}Mn_{z}O₂ (where x, y, z are 0<x<1, 0<y<1, 0<z<1, x+y+z=1). In addition to Li, Ni, Co, Mn, LNCM may contain other additive elements, such as transition-metal elements other than Ni, Co, Mn, and typical metal elements other than Li. LNCM has a layered crystalline architecture. LNCM may be more than 50% by mass of the entire positive electrode active material, for example, 80 to 100% by mass. The positive electrode active material may be composed only of LNCM.

Examples of other positive electrode active materials include a lithium nickel composite oxide, a lithium cobalt composite oxide, and a lithium nickel manganese composite oxide.

Examples of the conductive material include non-graphitizable carbon, graphitizable carbon such as carbon black, and graphite.

### Separator

The separator is an electrically insulating porous film. The separator electrically isolates the positive electrode and the negative electrode. The separator may have a thickness of, for example, 5 to 30 μm. The separators may be formed of, for example, a porous polyethylene (PE) membrane, a porous polypropylene (PP) membrane, or the like. The separator may have a multilayer structure. For example, the separators may be formed by laminating a porous PP membrane, a porous PE membrane, and a porous PP membrane in this order. The separator may have a heat resistant layer on its surface. The heat resistant layer includes a heat resistant material. Examples of the heat resistant material include metal oxide particles such as alumina, and high melting point resins such as polyimide.

### Battery Case

The battery case may have, for example, a rectangular shape (a flat rectangular parallelepiped) or a cylindrical shape. For example, a metal such as aluminum (Al) or Al composes the battery case. However, as long as the battery case has a predetermined sealing property, for example, a composite material of metal and resin may constitute the battery case. Examples of the composite material of metal and resin include an aluminum laminate film and the like. The battery case may include an external terminal, a liquid injection hole, a gas discharge valve, a current cutoff device (CID), and the like.

### Use

The non-aqueous secondary battery according to the present embodiment is expected to stably allow repeated Li dissolution and precipitation even when the battery is repeatedly charged and discharged, thereby improving the sustainability of the discharge capacity and improving the cycling properties. Examples of applications of the non-aqueous secondary batteries according to the present embodiment include power sources such as hybrid electric vehicle (HEV), plug-in hybrid electric vehicle (PHEV), battery electric vehicle (BEV), and the like.

Examples are shown below. The present disclosure will be described in more detail.

### Preparation of Electrolyte Solution

As an electrolyte, LiPF₆ was measured in a predetermined quantity. That is, when the target was 1 mol/L, it was measured so as to be equivalent to 0.01 mol. This was added to the solvents listed in Table 1 and dissolved.

The electrolyte dissolved in the solvents was 10 mL transferred to a volumetric flask and scaled up so that the electrolyte solution volume became 10 mL. Then, an electrolyte solution was obtained.

The amounts (m ol/L) of the electrolyte (LiPF₆) and the amounts (volume %) of the solvents (fluoroethylene carbonate (FEC) and ethylene carbonate (EC)) used in the respective examples and comparative examples are shown in Table 1.

### Cell Fabrication

LiNiₓCo_{y}Mn₍₁₋ₓ₋₇₎O₂(x=0.5, y=0.2) and a conductive aid, a binder was applied to Al foil, and pressed to produce a positive electrode.

An electrolytic copper foil was used as the negative electrode, and the positive electrode was opposed to the positive electrode via separators made of polyethylene (PE), and an electrolyte solution was injected to produce a coin cell. Note that the negative electrode containing the metallic Li is formed by depositing Li on the electrolytic copper foil during charge.

### Cell Evaluation

Cell activation was carried out at a current density of 0.4 mA/cm² ranging from 3.0 to 4.3V.

A 30-cycle test was then performed with a current density of 4 mA/cm², ranging from 3.0 to 4.3V.

The discharge capacity retention ratio was calculated by dividing the discharge capacity of the 30th cycle of the cycle test by the discharge capacity of the 1 st cycle of the cycle test. Further, the discharge capacity retention ratio of each of the Examples and Comparative Examples was divided by the discharge capacity retention ratio of Comparative Example 1 to calculate the “discharge capacity retention ratio ratio”. The results are shown in Table 1.

TABLE 1

| | Electrolyte | Solvent | | | Discharge |
|---|---|---|---|---|---|
| | LiPF₆ | FEC | EC | PC | capacity |
| | mol/L | Volume % | | | retention ratio |
| Comparative | 1.0 | 80 | 20 | — | 1.00 |
| Example 1 | | | | | |
| Example 1 | 1.0 | 85 | 15 | — | 1.08 |
| Example 2 | 1.0 | 90 | 10 | — | 1.11 |
| Example 3 | 1.0 | 100 | 0 | — | 1.07 |
| Comparative | 0.8 | 90 | 10 | — | 1.03 |
| Example 2 | | | | | |
| Example 4 | 1.5 | 90 | 10 | — | 1.14 |
| Example 5 | 2.0 | 90 | 10 | — | 1.16 |
| Comparative | 2.2 | 90 | 10 | — | 1.04 |
| Example 3 | | | | | |
| Comparative | 1.0 | 80 | — | 20 | 0.98 |
| Example 4 | | | | | |
| Example 6 | 1.0 | 90 | — | 10 | 1.09 |

Table 1 shows the following.
LiPF₆:6 lithium fluoride phosphate
EC: ethylene carbonate
PC: propylene carbonate
5 FEC: fluoroethylene carbonate

Fluoroethylene carbonate (FEC) and LiPF₆ are thought to form an inorganic-based coating such as LiF upon decomposition, and the hardness of the coating can be controlled by the content thereof.

On the other hand, cyclic carbonates containing FEC are considered to be easy to form long-carbon-chain organic coatings upon decomposition, and the flexibility of the coating can be controlled by the content thereof.
In Examples 1, 2, 3, and 6, it is considered that the ratio of FEC and another cyclic carbonate in the solvents was appropriately blended and exhibited good cycling properties.

In addition, the coordination between Li ions and the solvent-anion (PF₆⁻) varies depending on the salt concentration. A higher concentration promotes the decomposition of the anion. If the concentration is too high, the electrolyte solution becomes highly viscous, Li diffuses slowly, and dendrite-growth may be promoted.

In Examples 2, 4, and 5, it is considered that the electrolyte solution configuration in which the good coating film is formed and the diffusion of Li is ensured, the discharge capacity maintaining property is improved, and the good cycling property is exhibited.

What is claimed is:

1. A non-aqueous secondary battery comprising:
a negative electrode including metallic Li;
a positive electrode;
a separator; and
an electrolyte solution, wherein the electrolyte solution contains a fluorinated ethylene carbonate as a solvent in 85% or more by volume to a total amount of the solvent, and contains LiPF₆ as an electrolyte in 1.0 mol/L to 2.0 mol/L.

2. The non-aqueous secondary battery according to claim 1, wherein the electrolyte solution includes a non-fluorinated cyclic carbonate as the solvent.

3. The non-aqueous secondary battery according to claim 2, wherein the non-fluorinated cyclic carbonate is at least one of an ethylene carbonate and a propylene carbonate.

4. The non-aqueous secondary battery according to claim 3, wherein:
a ratio of a content of the fluorinated ethylene carbonate and a total content of the ethylene carbonate and the propylene carbonate in the solvent are from 85:15 to 95:5; and
a content of LiPF₆ is 1.5 mol/L to 2.0 mol/L.
